(19) United States
(12) Patent Application Publication
(10) Pub. No.: US 2003/0204005 A1
(43) Pub. Date: Oct. 30, 2003

(54) Polyester composition for reducing inter-bottle friction and poylester bottle manufactured from the same

(75) Inventor: Zo-Chun Jen, Taipei (TW)

Correspondence Address: Johnson & Associates, P.C., #282, 14625 Baltimore Avenue, Laurel, MD, 20707, US

(73) Assignee: NANYA Plastics Corp.

(21) Appl. No.: 10/284,505

(22) Filed: Oct. 31, 2002

(30) Foreign Application Priority Data
Apr. 29, 2002 (TW) 91108891

(51) Int. Cl. C08K 3/26

(52) U.S. Cl. 524/425

(57) ABSTRACT

This invention discloses a novel, polyester-resin composition containing CaCO₃ having inter-bottle friction reduction properties used to manufacture polyester bottles. The polyester resin composition contains preferably between 20-150 ppm CaCO₃, which has a reflective index or refrangibility of 1.65, and particle grain size of preferably between 0.5 and 5 micrometers. The polyester/CaCO₃ composition of this invention when used to manufacture polyester bottles reduces surface friction between polyester bottles during stacking, manufacturing transportation and commercial transportation while preserving acceptable commercial bottle transparency. The polyester-resin composition of this invention is first made into parison and then blown molded into polyester bottles of desired shapes.

### BACKGROUND OF THE INVENTION

This invention relates to a novel polyester resin composition use to manufacture polyester bottles. Specifically, this invention relates to a polyester resin composition containing CaCO₃ preferably between 20-150 ppm CaCO₃, which has a reflective index or refrangibility of 1.65 and particle of grain size preferably between 0.5 and 5 micro meters. The polyester resin composition of this invention is first made into parison then subsequently blown molded into polyester bottles of desired shapes. The presence of CaCO₃ within the polyester resin composition use to manufacture polyester bottles reduces surface friction between bottles during stacking, manufacturing transportation and commercial transportation, while preserving good transparency.

Polyester has long been used to manufacture polyester bottles. The most use polyester is polyethylene terephthalate (hereafter “PET”). PET is the polyester of choice because of its friendly manufacturing nature, and its ability to produce polymer bottles having fine intensity and requisite transparency. To produce polyester bottles, usually PET raw materials are cut to form granules, the granules are formed into parisons through the use of injection molding technology, the parisons are heated and blown up to form polyester bottles. The manufactured bottles are transported from the blowing molding equipment by use of conveyor belts, stacked and conveyed to their desired destination. During stacking and transporting, bottles surfaces come into frequent contact with one another. When polyester bottle come in frequent contact they generate some form of adhesive bonding. Unwanted adhesive bonding between bottles promote higher inter-bottle friction and negatively influence bottle transportation and overall operational efficiency. When polyester bottles are filled with edible liquid or other forms of liquid and stacked together for transportation to commercial destination, increased inter-bottle friction often results. Some bottles are destroyed before reaching their commercial destination. Premature destruction of polyester bottles due to inter-bottle friction can have severe financial consequences on operational capital.

Many attempts have been made to design polyester bottles with the ability to reduce inter-bottle friction during manufacturing and commercial transportation. In U.S. Pat. No. 5,830,544 un crystallized SiO₂ adopted as anti-blocking agent is included in the polyester-resin composition to reduce inter-bottle friction and adhesive bonding. This approach is limited because only a small quantity of SiO₂ between 20 and 60 ppm, can be added to the polyester composition. Excessive addition of SiO₂ resulted in unacceptable commercial polyester bottles having reduced transparency.

Other types of inorganic agents have been included in polyester composition used to manufacture polyester bottles, but have largely been unsuccessful. For example, other types of inorganic agents have resulted in rougher polyester films, which when used to manufacture polyester bottles caused increased inter-bottle friction during stacking, manufacturing and commercial transporting.

Numerous prior arts with disclosed the use of inorganic agents within polyester composition having reduced inter-bottle surface friction characteristics.

U.S. Pat. No. 5,935,700 teaches that SiO₂, TiO₂, and CaCO₃ can be used to increase smoothness in polyester film surfaces by maintaining the addition level of inorganic particles in relations to the total polyester film composition at between 0.05-0.5% weight. U.S. Pat. No. 5,674,618 teaches that ZnO can be used to increase smoothness in polyester film surfaces by maintaining the level of ZnO inorganic particles in relation to the overall weight of the polyester film at between 0.01 and 0.5% weight. A third patent, U.S. Pat. No. 4,595,715, teaches that kaolin clay and CaCO₃ can be used to increase smoothness in polyester film surfaces. This patent describes inorganic particle addition level as follows:

1000 ppm≦kaolin+CaCO₃≦10000 ppm

Finally U.S. Pat. No. 5,475,046 teaches that SiO₂ and Al₂O₃ can be used to reduce friction coefficient of polyester film surfaces by maintaining the addition level of the inorganic agents in relation to the total amount of polyester film between 0.001 and 0.01% weight of SiO₂ and 0.001-0.1 wt % of Al₂O₃ respectively

Prior to this invention, all the prior arts geared towards reducing inter-bottle friction amongst polyester film surfaces have failed to achieve their desired objectives. The prior arts have failed to invent polyester bottles comprising polyester films with decreased coefficient of friction, films having enhanced levels of smoothness, films capable of reducing adhesive bonding and/or films with commercial acceptable transparency.

Therefore, it is an object of this invention to produce polyester films use to manufacture polyester bottles with a novel anti-blocking agent. Using this invention will enable polyester films/bottles possess increase smoothness, will reduce inter-bottle friction, will reduce adhesive bonding amongst bottles, will improve commercial and manufacturing transportation and enhance manufacturing efficiency.

It is an object of this invention to realize the objective mentioned in the immediate paragraph above by adding to the polyester composition CaCO₃ preferably between 20 and 150 ppm. Said CaCO₃ particles have reflective index of about 1.65, and particle grain size of preferably between 0.5 and 5 micro meters.

### SUMMARY OF THE INVENTION

This invention relates to a polyester resin composition for manufacturing polyester bottles containing CaCO₃, which assist in reducing adhesive bonding among polyester bottle surfaces during transportation while maintaining the desired level of transparency required for commercial use. The invention of this application teaches the use of an alternative inorganic anti-blocking agent, CaCO₃, for use in manufacturing polyester films use to manufacture polyester bottles.

The acceptable quantity of CaCO₃ use in relations to the total polyester composition should fall preferably between 20 and 150 ppm, although quantities between 40 to 100 ppm is strongly preferred. The preferred grain size of CaCO₃ should fall preferably between 0.5 and 5 micrometers, although grain size between 1 to 3 micrometers is strongly preferred. The reflective index of the CaCO₃ use in this invention is preferably 1.65.

### DETAILED DESCRIPTION OF THE INVENTION

Using preferred ranges and indicators of CaCO₃ as indicated by this invention will reduce surface inter-bottle friction amongst polyester bottles during stacking, commercial and manufacturing transportation while producing bottles with commercially acceptable transparency levels. CaCO₃ can be added to the polyester composition anytime during the manufacturing process. That is, during the dibasic acid and glycol mixing process, during the esterification reaction process, or during the aggregation reaction process.

CaCO₃ and ethylene glycol (EG) are mixed to form a slurry then milled to form a homodisperse state absent coagulation. The preparation concentration of CaCO₃ is preferably between 1 and 50% weight of the total mixture, although having ratios between 5 and 30% of the total mixture is strongly preferred. It has been observed that when CaCO₃ addition is ≦20 ppm, reduction in inter-bottle friction and adhesive bonding between polyester bottles are non-existent. When CaCO₃ addition is ≧150 ppm polyester films used to manufacture polyester bottles possess poor and unacceptable level of transparency. Similarly, when the CaCO₃ grain size is <0.5 micrometer no or little inter-bottle friction reduction and adhesive bonding are observed, and when CaCO₃ grain size is ≧0.5 micrometer the polyester films used to manufacture the polyester bottles failed to demonstrate acceptable commercial transparency levels.

Thus, the preferred addition of CaCO₃ in relations to the total polyester composition is preferably between 20 to 150 ppm, although 40 to 100 ppm is strongly preferred. The preferred grain size of CaCO₃ is preferably between 0.5 and 5 micrometers, although grain size between 1 and 3 micrometers is strongly recommended. Finally, CaCO₃ particles with reflective index of about 1.65 are preferred are similar and more often equal to the PET polyester composition's reflective index.

A wide range of polyester resins can be used as starting materials for this invention. Generally polyester resins can be produced from esterifying of a dibasic acid and a diol, or by transesterifying of a diester such as dimethyl terephthalate (DMT) and a diol. The most used dibasic acid is terephthalic acid (TPA) and the most used diol is ethylene glycol (EG). It is well known that a polyester resin composition can consist of two or more dibasic acid and/or two or more diols. Examples of acid ingredients that can be used to manufacture polyester resins of this invention are iso-phthalic acid, succinic acid, glutaric acid, adipic acid, sebacic acid or mixture of analog comprising any of the previously mentioned acid. Examples of alcohol ingredients that can be used to manufacture the polyester resin of this invention are diethylene glycol, 1,3-propane glycol, 1,4-butane glycol or mixture of analog of any of the previously mentioned alcohol.

A common method of manufacturing polyester resins used in the manufacturing of polyester bottles reacts trephthalic acid and glycol preferably between 210 to 240° C. to form monomer and water. Water is continuously removed during reacting of the terephthalic acid with the glycol. During this reaction, a catalyst or an accelerant is not required because adding a catalyst or accelerant will only slightly speed up the reaction and reaction enhancement are not noticeable. However, addition of accelerant or catalyst increases diethylene glycol (DEG) production. After successful esterification of the terephthalic acid and the glycol the reaction is subsequently placed through an aggregation/condensation reaction comprising a pre-polymerization reaction and a main polymerization reaction.

The pre-polymerization reaction occurs preferably between 270-280° C. and at an operational vacuum pressure preferably between 250-15 mmHg. The main polymerization occurs preferably between 275 to 285° C. and at an operational vacuum pressure preferably below 1 mmHg. At these preferred temperatures and pressures the aggregation/condensation reaction is successfully performed. At the end of the PET melt phase aggregation, PET polymer intrinsic viscosity (IV) value usually increases from about 0.5 to 0.7 dl/g. At this point, the polymer is uploaded to the cooling water bath for quick chilling and subsequently cut into cylindrical ester chips.

In order to increase the intrinsic viscosity (IV) value of the PET polymer to obtain the desired polymer required to manufacture the polyester bottles, solid phase polymerization of the ester particle is performed at 200° C. in the presence of nitrogen gas, which increases the IV value to preferably between 0.7 to 1.1 dl/g, although increasing the IV from between 0.72-0.88 dl/g is strongly preferred. If the temperature of the solid phase polymerization is lower than 200° C., the intrinsic viscosity (IV) value slowly increases.

At temperatures below 200° C. the chances of performing a successful solid phase polymerization reaction needed to produce the desired polymer films are greatly reduced. The next series of steps involve crystallizing and drying the ester particles, molding the ester particles into parison through the use of bottle blowing machine, and then blowing the ester particles to obtain bottles of desired shapes.

Reacting CaCO₃ with the polyester resin composition between the preferred ranges disclosed in this invention have been found to improve inter-bottle friction of produced polyester bottles and enhance bottles' transparency. Thus, mixing a polyester resin composition with inorganic CaCO₃ particles using the latter preferred weight percentage, the preferred reflective index, the latter preferred particle grain size, at the latter preferred operating temperatures and pressures, along with having a mixture composition having the requisite intrinsic viscosity have been found to positively influence the objective of manufacturing polyester films with reduced inter-bottle friction and enhanced transparency. In short the preferred sizes, temperatures, intrinsic viscosities, and weight percentages of this invention are critical to achieving this present invention.

Other forms of additive can be added along with inorganic CaCO₃ particles to the polyester resin composition. These additives include, but are not limited, to heat stabilizer, optical tranquilizer, dye, colorant, plasticizer, antioxidant, infra absorbents and anti-uv agents, etc. Using CaCO₃ with additional additive, for example plasticizer, still maintained transparency and reduced inter-bottle friction in manufactured polyester films and between bottles manufactured from said films.

Static friction coefficient and kinetic friction coefficient of manufactured polyester bottles were measured using friction coefficient instrumentation such as the ASTM D1894-78. The bottles were tested for static friction and kinetic friction coefficients by obtaining ester particles chips from the bottles. Ester particles chips from the bottles were cut into 7 cm² ester chips and then fastened to a test sled of a friction coefficient instrument. Additional 35 cm×13.5 cm ester chips were removed from the polyester bottle (s) to be tested and fastened to a test sled and placed on the stage of the friction coefficient instrument. The sled containing cut ester chips was placed on the test stage, and pulled with a fixed speed of 20 cm/min to test the static friction coefficient and kinetic friction coefficient of the manufactured polyester bottle(s). The relationship between friction coefficient μ and friction is F=μ×200 g, where the latter (200 g) is the sled weight. The static friction coefficient, which is the strength required to remove static sled, is calculated using the formula F=μ×200 g. The kinetic friction coefficient which is the friction during the movement of the sled is calculated using the formula F=μ×200 g. Based on the relationship between the friction coefficient and the friction force, the less the friction the less the friction coefficient is and the less the extent of adhesive bonding between polyester bottles surfaces. There is a direct correlation between the friction correlation and the frictional force.

Finally, comparison between CaCO₃ and SiO₂ produced polyester films/polyester bottles revealed the former with considerable advantages in reducing film surface friction and haze generated during manufacturing. For example, U.S. Pat. No. 5,830,544 uses un crystallized SiO₂ between 0.001 and 0.01 wt % of the total mixture as anti-blocking agent to reduce inter-bottle friction and adhesive bonding. Based on the exploitation and comparison examples delineated below, addition of CaCO₃ and SiO₂ at 100 ppm respectively resulted in CaCO₃ produced films having a lower coefficient of friction. Similarly, addition of CaCO₃ at 100 ppm resulted in manufactured polyester films with less haze than polyester films manufactured with SiO₂ at comparable addition levels.

The equipment used in conducting the haze test is the COLOR AND COLOR DIFFERENCE METER, MODEL 1001DP manufactured by NIPPON DENSHOKU KOGYO CO., LTD.

### EXAMPLE OF EXPLOITATION

PET oligomers 12.11 Kg and EG 3.87 Kg were added into a electric heated stainless steel 30 litre reactor, agitated and heated under atmosphere to 260° C., and EG in the amount of 1200˜1400 ml is collected. The PET oligomers were obtained through reacting PTA and EG. Prior to the aggregation reaction, the following ingredients/quantities were added to the PET mixture composition: 450 ppm antimony acetate, aggregation accelerant; 140 ppm cobalt acetate and CaCO₃ having an average particle size of 2 micrometer.

To effectively analysis the impact of CaCO₃ on the polyester composition, three addition concentrations of CaCO₃ were adopted: 100 ppm, 50 ppm and 20 ppm respectively. The process steps are as follows: a reactor was vacuumed and decreased to pressures below 1 mmHg to perform the pre-polymerization reaction at a temperature of 270° C., and to perform the main polymer reaction at 280° C. to produce the co-polyester resins; the intrinsic viscosity of the co-polyester was controlled between 0.6˜0.64 dl/g; the resulting polymer was cut into granules, dried and crystallized for 6 hours under 180° C. nitrogen gas; and the mixture underwent solid aggregation reaction at a temperature of 225° C. for 20 hours and with an intrinsic viscosity between 0.76˜0.86 dl/g.

The polyester particles after solid aggregation reaction were processed into polyester bottles through 280° C. ejectors. The friction coefficient and haze of the polyester films/polyester bottles produced from the three CaCO₃ concentrations were measured using the ASTM D1894-78 and the MODEL 1001 DP instrumentations respectively.

### EXAMPLE OF COMPARISON

PET oligomers 12.11 Kg and EG 3.87 Kg were added into a electric heated stainless steel 30 litre reactor, agitated and heated under atmosphere to 260° C., and EG in the amount of 1200˜1400 ml is collected. The PET oligomers were obtained through reacting PTA and EG. Prior to the aggregation reaction, the following ingredients/quantities were added to the PET mixture composition: 450 ppm antimony acetate, aggregation accelerant; 140 ppm cobalt acetate and SiO₂ having an average particle size of 1.3 micrometer. To effectively analysis the impact of SiO₂ on the polyester composition, three addition concentrations of SiO₂ were adopted: 100 ppm, 50 ppm and 20 ppm respectively.

The process steps are as follows: a reactor was vacuumed and decreased to pressures below 1 mmHg to perform the pre-polymerization reaction at a temperature of 270° C., and to perform the main polymer reaction at 280° C. to produce the co-polyester resins; the intrinsic viscosity of the co-polyester was controlled between 0.6˜0.64 dl/g; the resulting polymer was cut into granules, dried and crystallized for 6 hours under 180° C. nitrogen gas; and the mixture underwent solid aggregation reaction at a temperature of 225° C. for 20 hours and with an intrinsic viscosity between 0.76˜0.86 dl/g. The polyester particles after solid aggregation reaction were processed into polyester bottles through 280° C. ejectors. The friction coefficient and haze of the polyester films/polyester bottles produced from the three SiO₂ concentrations were measured using the ASTM D1894-78 and the MODEL 1001 DP instrumentations respectively.

What is claimed:

1. A polyester-resin composition having inter-bottle friction reducing properties used for manufacturing polyester bottles and capable of being shaped into parison through blow molding comprising the following:
(a) polyester; and
(b) inorganic particles

2. The polyester of the polyester-resin composition, according to claim 1 is made of polyethylene terephthalate and modified polyethylene terephthalate.

3. The polyester of the polyester-resin composition, according to claim 1 wherein said inorganic particles are CaCO₃.

4. The polyester-resin composition according to claim 3, wherein the addition concentration of CaCO₃ to the polyester-resin composition is between 20 and 150 ppm.

5. The polyester-resin composition according to claim 3, wherein the addition concentration of CaCO₃ to the polyester-resin composition is between 40-100 ppm.

6. The polyester-resin composition according to claim 4, wherein the addition concentration of CaCO₃ to the polyester-resin composition is between 40-100 ppm.

7. The CaCO₃ particles according to claim 4, wherein said particles have a reflective index of 1.65.

8. The CaCO₃ particles according to claim 6, wherein said particles have a reflective index of 1.65.

9. The CaCO₃ particles according to claim 7, wherein said particles have grain size between 0.5 and 5 micrometers.

10. The CaCO₃ particles according to claim 8, wherein said particles have grain size between 0.5 and 5 micrometers.

11. The CaCO₃ inorganic particles according to claim 9, wherein said grain size is between 1 and 3 micrometers.

12. The CaCO₃ inorganic particles according to claim 10, wherein said grain size is between 1 and 3 micrometers.

13. The polyester-resin composition according to claim 2, wherein the addition concentration of said inorganic particles to the polyester-resin composition is between 20 and 150 ppm.

14. The inorganic particles according to claim 13, wherein the addition concentration is between 40 and 100 ppm.

15. The inorganic particles according to claim 14, wherein said particles have a reflective index of 1.65.

16. The inorganic particles according to claim 15, wherein said particles have grain size between 0.5 and 5 micrometers.

17. The inorganic particles according to claim 16, wherein said particles have grain size between 1 and 3 micrometers

18. The polyester-resin composition according to claim 11, consisting essentially of heat stabilizer, optical tranquilizer dye, colorant, plasticizer, antioxidant, infra absorbents and anti-uv agents.

19. The polyester-resin composition according to claim 12, consisting essentially of heat stabilizer, optical tranquilizer dye, colorant, plasticizer, antioxidant, infra absorbents and anti-uv agents.

20. The polyester-resin composition according to claim 17, consisting essentially of heat stabilizer, optical tranquilizer dye, colorant, plasticizer, antioxidant, infra absorbents and anti-uv agents.
